(19) United States
(12) Patent Application Publication
(10) Pub. No.: US 2005/0085686 A1
(43) Pub. Date: Apr. 21, 2005

(54) Protective means and apparatus

(76) Inventor: Chi Yee Michael Yuen, Hong Kong (CN)

Correspondence Address: BURNS DOANE SWECKER & MATHIS L L P, POST OFFICE BOX 1404, ALEXANDRIA, VA, 22313-1404, US

(21) Appl. No.: 10/849,304

(22) Filed: May 20, 2004

(30) Foreign Application Priority Data
Oct. 17, 2003 (CN) 200310101953.9

(51) Int. Cl. A61G 10/00

(52) U.S. Cl. 600/21; 312/1

(57) ABSTRACT

Patient access interfacing means and patient isolation means comprising same. The means comprising adjustable patient viewing means, patient access guards and means for attaching to the patient isolation apparatus, the adjustable patient means including means for visual examination of a patient, the means for attaching to the patient isolation apparatus including sealing means for sealing a junction between the patient isolation apparatus and the patient access interfacing means, patient access guards being adapted for allowing non-exposed manual access by the hands of an operator to the patient under protected conditions, the patient viewing means and the patient access guards being mounted on a main platform which is supported on inflatable means so that the distance of the main platform relative to the main housing being adjustable through inflation and deflation of the inflatable means.

### FIELD OF THE INVENTION

The invention relates to protective means and apparatus for medical application. More particularly, this invention relates to protective or isolation means for shielding medical personnel from a patient suffering from highly contagious respiratory illness during examination and/or treatment.

### BACKGROUND OF THE INVENTION

Medical professionals and personnel are constantly exposed to biological contaminated secretions or air particles discharged by patients during examination and/or treatment. For example, when a medical practitioner is examining or treating a patient with a highly contagious respiratory illness who is in need of ventilatory support, life saving procedures, for example, endotracheal intubation (placing a rubber tube into the larynx of the patient), will pose a tremendous degree of risk exposure to the surrounding medical personnel and practitioners. In dealing with patients with such contagious conditions, isolation means conforming to a Classes 1-3 bio-safe cabinet should be used to ensure maximum biological security. Top end expensive space (or moon) suits with their own air supply are an example of safety suits that can be used by medical practitioners to protect themselves. However, such suits are expensive, clumsy and not suitable for general or emergency medical applications.

U.S. Pat. No. 6,001,057 discloses a self-contained isolation and environmental protection system for shielding a patient contained therein and isolating a contaminated patient from a claimed environment while allowing treatment of traumatic injuries to the patient. However, such a system does not provide easy access for medical practitioners who need to have access to the upper body of the patient for examination and/or treatment.

U.S. Pat. No. 6,321,764 describes a collapsible isolation apparatus for preventing contaminations of hazardous biological and chemical materials. A plurality of glove box ports are provided along the lateral sides of the apparatus to allow rapid and convenient treatment of the patient. However, the accessible ranges of the gloves are limited and restricted by their pre-determined positions and there are no convenient and flexible means for viewing and examining the conditions of a patient.

U.S. Pat. No. 5,728,041 and U.S. Pat. No. 6,461,290 describe isolation means similar to those mentioned above and are not satisfactory.

Hence, it is highly desirable if there can be provided improved protective means or apparatus in the form of protective chambers or shields to isolate a patient from the surrounding environment while allowing flexible access to and closer visual examination of the patient by medical practitioners for necessary examination and treatment, especially for performing life saving procedures such as intubation on a patient with highly contagious respiratory illness while alleviating the risk on medical practitioners.

### OBJECT OF THE INVENTION

Accordingly, it is an object of the present invention to provide protective or isolation means or apparatus for isolating a patient from the surrounding environment while providing means for convenients visual and manual access to the patient to perform necessary examination and/or treatment more safely and conveniently. Additionally, it is also an object of this invention to provide an isolation means or apparatus so that bronchial dilators or steroids can be administered to a patient in the form of aerosol or by way of nebulizers whenever necessary while alleviating the risk of contamination to the surrounding environment. At a minimum, it is an object of this invention to provide the public with a useful choice of isolation chambers suitable for use for examining or treating a patient while isolating the patient from the surrounding environment for the benefit of the public.

### SUMMARY OF THE INVENTION

Broadly speaking, the present invention has described an isolation chamber for examining and/or treating a patent, comprising:
a main housing for covering at least the upper body of a patient, said housing being adapted so that the upper body of said patient being substantially isolated from the surrounding environment when said isolation chamber is set up for normal use, said housing including an access aperture disposed at a location corresponding to near the head of said patient during use and being adapted for detachably receiving patient access interfacing means,
patient access guards adapted for allowing non-exposed manual access by the hands of an operator to the patient under protected conditions, * adjustable patient viewing means for visual examination of said patient, wherein said patient access guards and said adjustable patient viewing means being connected to a patient access interfacing means, said patient access interfacing means comprises a main platform which is supported on inflatable means so that the distance of said main platform relative to said main housing being adjustable through inflation and deflation of said inflatable means, and
said patient access interfacing means being detachably attached to said access aperture with sealing means sealing the injunction between said access aperture and said patient access interfacing means.

According to one specific aspect of the invention, there is provided patient access interfacing means for use with a patient isolation apparatus, comprising adjustable patient viewing means, patient access guards and means for attaching to said patient isolation apparatus, wherein, said adjustable patient means including means for visual examination of a patient, said means for attaching to said patient isolation apparatus including sealing means for sealing a junction between said patient isolation apparatus and said patient access interfacing means, patient access guards being adapted for allowing non-exposed manual access by the hands of an operator to the patient under protected conditions, said patient viewing means and said patient access guards being mounted on a main platform which is supported on inflatable means so that the distance of said main platform relative to said main housing being adjustable through inflation and deflation of said inflatable means.

Preferably, said viewing means being supported on an inflatable supporting means which is inflatable independently of said inflatable means of said main platform so that the distance of said viewing means and the patient being treated or examined can be adjustable through inflation or deflation of said inflatable support means.

Preferably, said independently inflatable support means comprises a plurality of inflatable rings stacked together.

Preferably, the cross-sectional internal diameters of said plurality of inflatable rings increase as the rings move away from said supporting platform.

Preferably, a transparent viewing window is sandwiched between said inflatable support means and another independently inflatable member.

Preferably, said patient access guards including a pair of gloves connected to said main platform respectively via a pair of flexible sleeves which intersect said main platform at first and second hand access apertures.

Preferably, said viewing window, said first and second hand access apertures being disposed respectively at 12 o'clock, 4 o'clock and 8 o'clock positions.

Preferably, said inflatable means of said man platform and said inflatable support means being communicable via a flow control means, said inflatable means of said main platform having a substantially large capacity than said inflatable support means and acts as an air buffer for said inflatable support means.

Preferably, said inflatable means supporting said main platform comprises a plurality of stacked together and independently inflatable rings which are disposed between said main platform and said access aperture during normal use.

Preferably, said patient access interfacing means comprises a sealing ring with a peripheral sealing skirt for sealing the junction between said access interfacing means and said access aperture.

Preferably, said main housing resembles a tunnel covering at least the top body of a patient during use, said main housing being integrally formed from a main transparent mouldable material.

Preferably, said housing being made of PE, PET, PC, PP, acrylic or materials of similar characteristics.

Preferably, said main housing including a suction aperture adapted for detachable connection with a suction means, said suction aperture being disposed near the head of a patient under treatment so that air inside said main housing being moved out of said main housing via said suction aperture.

### BRIEF DESCRIPTION OF THE DRAWINGS

Preferred embodiments of the present invention will be explained in further detail below by way of examples and with reference to the accompanying drawings, in which:

FIG. 1 is a plan view of a base mattress for use with the present invention, FIG. 2 is a cross-section of the mattress of FIG. 1,

FIGS. 3A and 3B are the front view of the main housing of the isolation chamber of this invention respectively showing the dimensions in centimeter and with reference numerals,

FIGS. 4A and 4B are the right side elevation view of the isolation chamber of FIG. 3 respectively with dimensions in centimeter and reference numerals,

FIGS. 5A and 5B are the top plan view of the main housing respectively with dimensions in centimeter and referencing numerals,

FIG. 6 shows a perspective view of a detachable patient access interfacing means of the present invention,

FIGS. 7A and 7B are a side elevation view of the patient access interfacing means of FIG. 6 respectively with dimensions in centimeter and referencing numerals,

FIG. 8 is a cross-sectional view showing the cross-section of the internal diameter of the constituting inflatable rings of the inflatable means supporting a viewing means,

FIG. 9 is a perspective view showing a pair of sleeves for attaching to the patient access interfacing means,

FIG. 10 is a top plan view of the patient access interfacing means,

FIG. 11 is a top plan view of FIG. 8,

FIG. 12 is a side view showing an alternative sleeve of different dimensions,

FIG. 13 is a front elevation view of the isolation chamber of the present invention when assembled,

FIG. 14 is a side elevation view of the isolation chamber of FIG. 13,

FIG. 15 is a schematic circuit diagram showing the air-flow paths during normal use of the isolation chamber,

FIG. 16 is a schematic air-flow diagram showing the directions of air movement during normal use of the isolation chamber with a patient placed inside the isolation chamber,

FIG. 17 is a top plan view illustrating in an alternative view the air-flow directions of FIG. 16,

FIG. 18 is an end-view of the isolation chamber during normal use, and

FIGS. 19A and 19B are the perspective view of a preferred embodiment of an instrument transit means suitable for use with the isolation chamber of the present invention respectively with exemplary dimensions and referencing numerals.

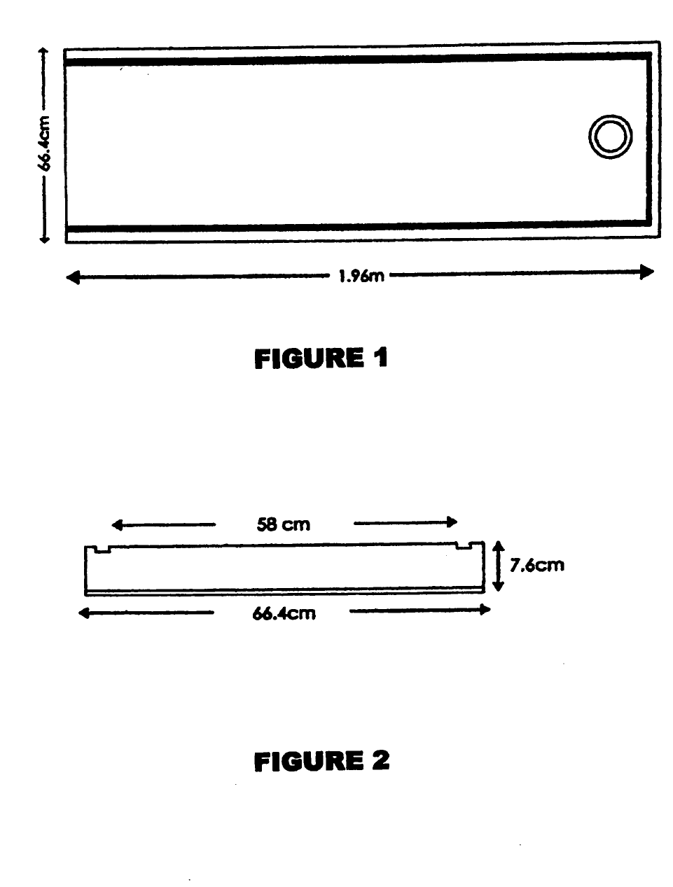

### DETAILED DESCRIPTION OF THE PREFERRED EMBODIMENTS

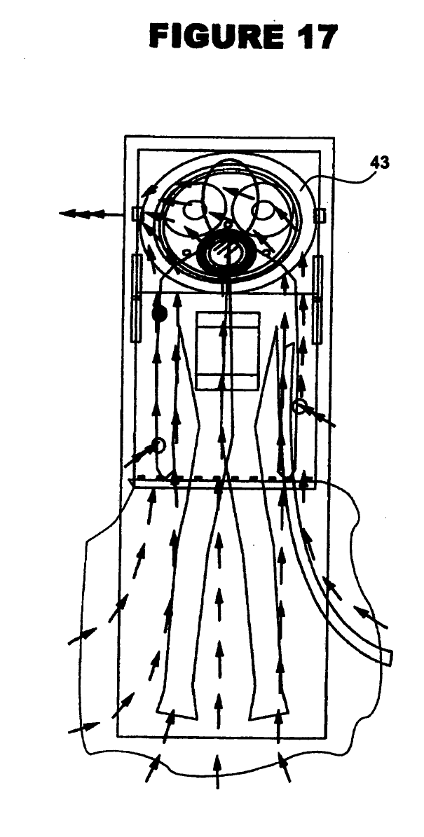

Referring to the Figures, there is shown a preferred embodiment of a patient isolation means comprising an isolation chamber equipped with exemplary accessories. As shown in FIGS. 15-18, the isolation means, in the assembled form, comprises a rigid main housing 10, patient access interfacing means 40, instrument transit means, a base and a flexible enclosure.

Rigid Main Housing

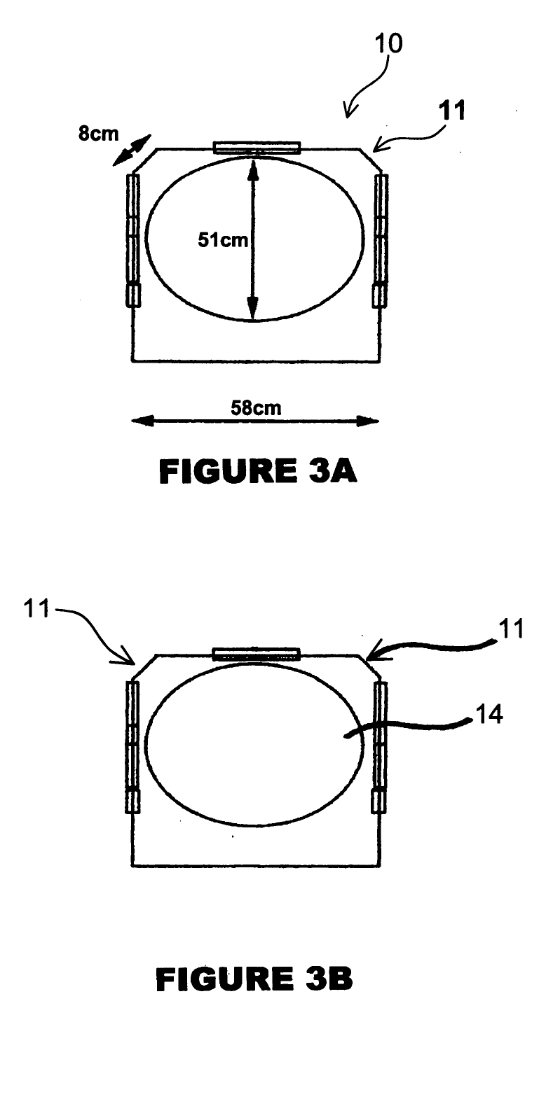

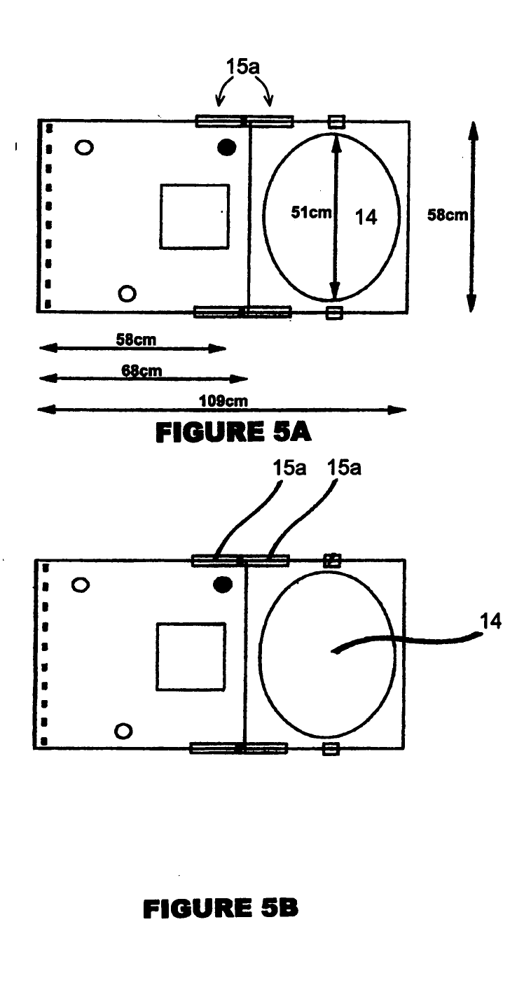

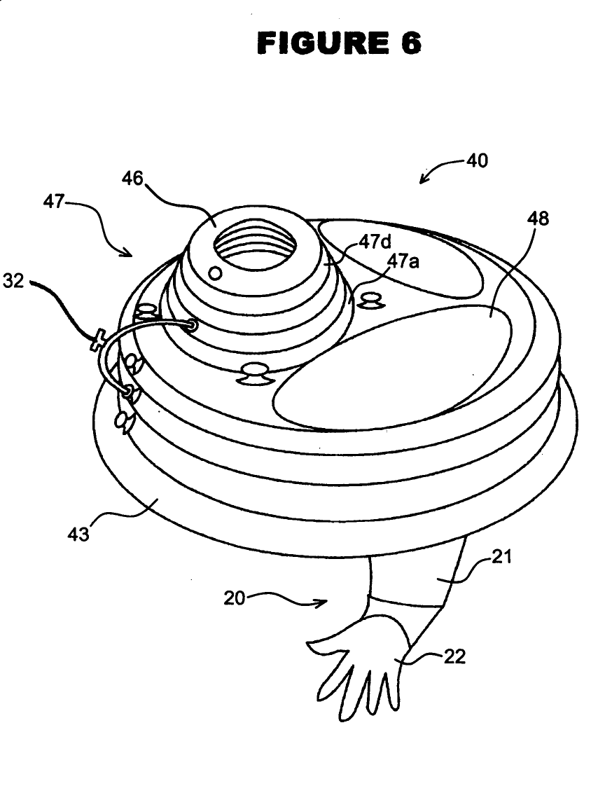

Referring to FIGS. 3A to 5, there is shown a rigid main housing 10 for covering the upper body of a patient so that the patient can be shielded and isolated from the surrounding environment. The rigid main housing 10 is configured as a semi-capsule so that the upper body of a patient is substantially surrounded by the top portion and the lateral side portions of the main rigid housing 10. In one perspective, the main rigid housing 10 may be viewed as being configured as a tunnel with the patient placed inside the tunnel. The main rigid housing 10 is substantially transparent and can be made of transparent plastics such as, for example, PE (polyethylene), PC (polycarbonate), PET, PP (polypropylene), acrylic, or other similar plastic materials or a mixture or combination of the appropriate transparent plastic materials. The rigid main housing can be formed by, for example, vacuum forming, blowing or vacuum injections. As can be seen from FIGS. 3A and 3B, the rigid main housing 10 comprises bevelled corners 11 intermediate the top and the lateral sides so that a patient can be more clearly seen from an elevation. The corners are preferably bevelled at 45° towards the base in the present examples. Alternatively, the rigid housing may be formed with an arcuate top similar to a tunnel so that the patient can be clearly viewed at several perspective angles.

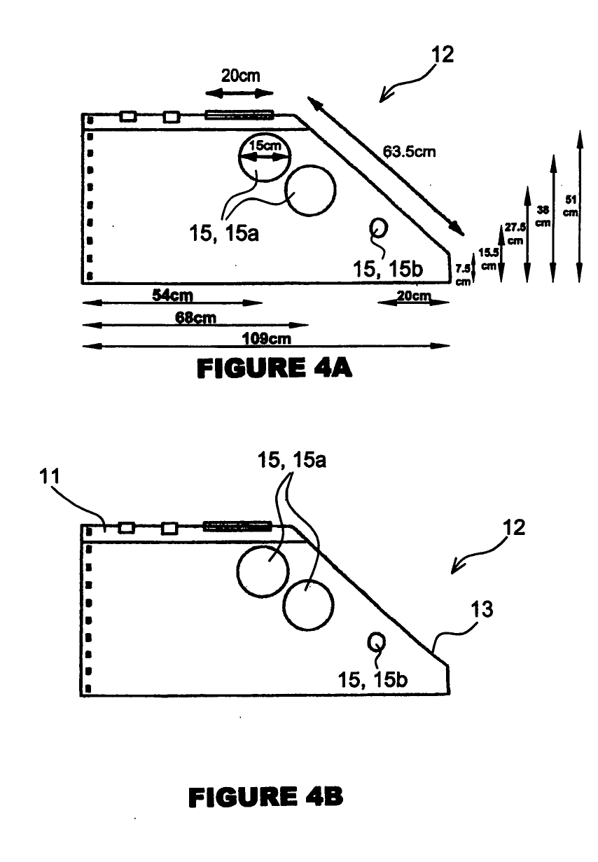

The front end of the rigid main housing 10 comprises a surface which tilts downwards towards the base with a main access aperture 14. Specifically, the tilting angle is 40° for conveniently receiving the patient access interfacing means 40. The main access aperture 14 is generally circular and occupies a substantial proportion of the front tilted surface. A plurality of ancillary apertures are also formed on the lateral side walls of the rigid main housing. For example, lateral patient access apertures 15, 15a as shown in FIGS. 4A and 4B are formed on each of the lateral sides. In addition, an exhaust aperture 15b is formed near the tapered front end of the isolation chamber for connection to a suction means for removal of air from inside the isolation chamber, thereby providing necessary ventilations. A patient access interfacing means, which are in the form of a pair of flexible guarded sleeves with gloves, are attached to the patient access apertures 15a to be explained below. An instrument access aperture is also formed on the top of the main housing so as to provide isolated access of the necessary instruments into the isolated chamber for use by a surgeon during examination or treatment.

Exemplary dimensions of the rigid main housing designed for an average Asian population are shown in FIGS. 3A and 4A in centimetres. Specifically, the rigid main housing 10 has an overall length of 109 cm, a height of 51 cm, a width of 58 cm. The diameters of the main access aperture 14 and the lateral patient access apertures 15 are respectively 51 cm and 15 cm. Other dimensions will be readily apparent from the relevant Figures.

Patient Access Guards

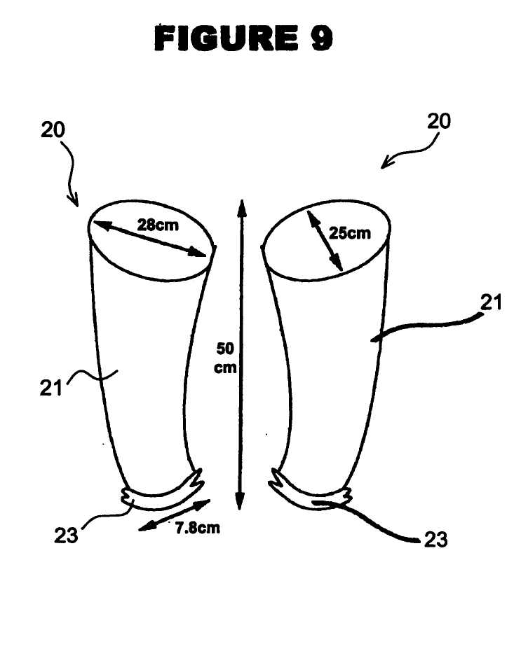

Patient access guards 20 are provided for guarded access of the hands of the medical practitioners to access the patient. As shown in FIGS. 6 and 9, the patient access guards 20 comprises a sleeve 21 with a glove 22 at one end and junction sealing means at the other. The glove 22 can be a latex glove commonly used in medical applications and the sleeve 21 can be formed of soft and flexible polymers or plastics such as PVC. Junction sealing means 23 comprising a sealing ring made, for example, of ambidextrous rubber is provided so that a water-proof and air-tight junction can be formed between the patient access aperture 15a on the rigid main housing and the sleeves 21. Also, the sealing ring can be made, for example, with a circumferential grove for detachable attachment to the aperture. The exhaust aperture 15b may be connected to an air filter, such as a HEPA or ULPA filter and with an optional flow meter to measure the volume rate of transfer of air from the isolation chamber to the contained outside.

The Flexible Enclosure

A flexible enclosure 30 for detachably covering the rear open end of the rigid main housing 10 is provided so that the lower body of a patient can be shielded. Such a flexible enclosure 30, in the form of a flexible canopy, is made of non-water permeable materials such as PVC or PE so that the lower body of a patient can be covered while leaving some flexibility so that oxygen supply, anaesthetic agents and/or suction anaesthetic pipe can be inserted into the isolation box when necessary.

Patient Access Interfacing Means

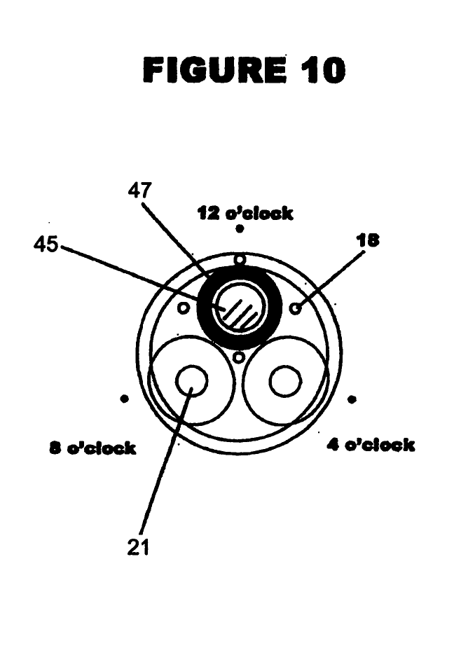

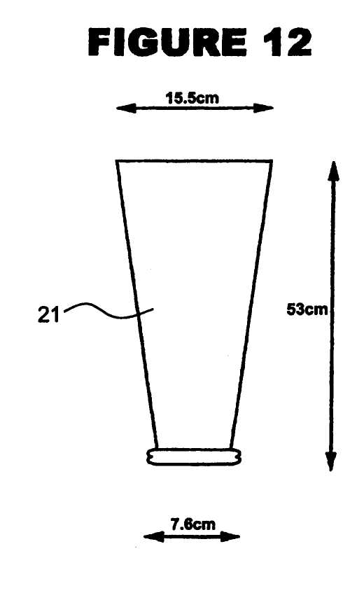

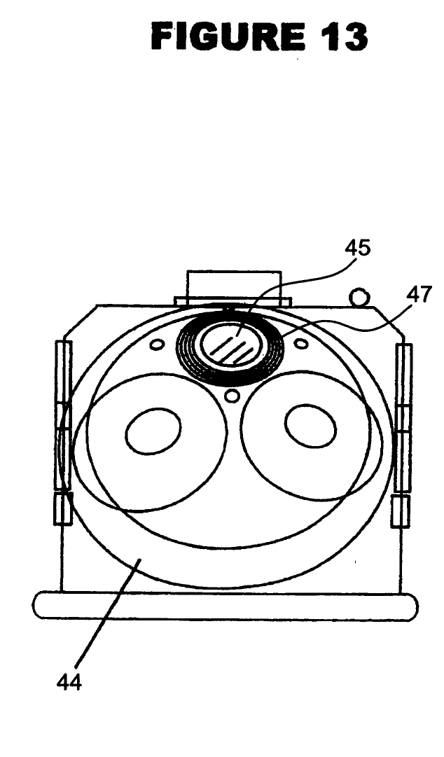

Referring to FIGS. 6-13, there is shown an exemplary embodiment of a patient access interfacing means 40 for detachable attachment to the main access aperture 14 on the front end of the rigid main housing 10. The patient access interfacing means 40 is attached to the front end, which corresponds to the location of a patient's head during use, since many hazardous procedures and contaminations originate from the head of a patient.

The patient access interfacing means 40 comprises patient viewing window 45 and patient access guards 20. The patient viewing window 45 is provided for visual examination of a patient being placed inside the isolation chamber while the hands of a medical practitioner can access a patient placed inside the isolation chamber under protected or guarded conditions. The viewing window comprises a transparent lens which is made, for example, of transparent plastics, such as polycarbonate. Both the viewing window 45 and the patient access guards 20 are mounted on a main platform formed on the patient access interfacing means 40. The viewing window 45 is mounted on a inflatable column or tower 47 so that its elevation above the main platform, and therefore the patient, can be adjustable by pneumatic means, such as, for example, by deflation or inflation. The viewing window 45 is sandwiched between the inflatable tower 47 and an air cushion 46 for receiving the head or face of a medical practitioner so that the height of the inflatable tower or column 47 can be adjustable by controlling the pressure asserted by the operating medical practitioner on the air cushion as explained below.

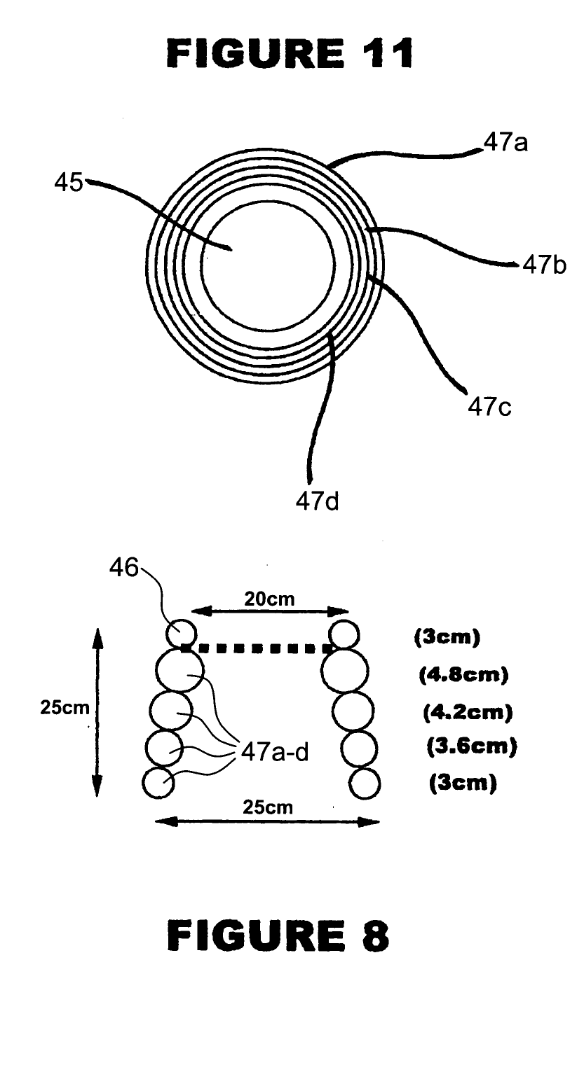

Turning to FIGS. 6, 8 and 11, the inflatable tower comprises a plurality of inflatable rings (47a-d) stacked together along a common axis. The constituting rings are communicable via channels interconnecting the constituting rings. The inflatable space of the inflatable tower is communicable with an air reservoir or buffer disposed in a separate inflatable means to be explained below and via a flow control means such as a tap or a valve 32. As can be seen from FIG. 8, the internal cross-sectional diameters of the constituting rings of the inflatable tower increases as it moves away from the main platform of the patient access interfacing means 40. A pair of hand access apertures 48 is formed on the main platform 43. This hand access aperture 48 provides access for the medical practitioner so that his hands can be inserted through the hand access apertures. A pair of patient access guards 20 is connected to the hand access apertures on the main platform. The patient access guards 20 can be integrally formed with the main platform or are detachably attached to the main platform with a clipping and sealing ring to prevent linkage through the junction of between the sleeve of the patient access guard 20 and the main platform. The main platform is supported on an inflatable base so that the distance of the main platform relatively to its lower end or the tilted front surface of the rigid main housing can be adjusted by pneumatic means such as, for example, by inflation and deflation of the inflatable support means.

The inflatable base 44 comprises inflatable supporting means which comprises a plurality of individually inflatable rings which are stacked together along a common axis so that the supporting means appears to comprise of a plurality of concentric rings pasted together. Each of the inflatable supporting rings of the supporting base includes a valve 32 so that the tautness can be controlled by inflation or deflation of the individual inflatable rings. During normal use, the patient access interfacing means 40 is detachably attached to the main access aperture 14 formed on the titled front surface of the rigid main housing with the inflatable power comprising the transparent viewing angle disposed at near 12 o'clock position with the hand access apertures at the 4 o'clock and 8 o'clock positions.

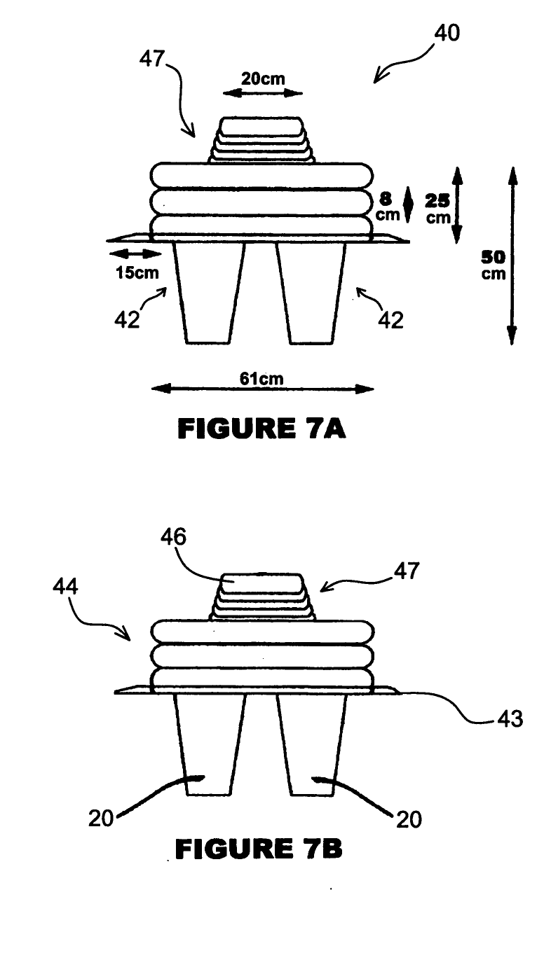

As shown in FIGS. 6, 7A and 7B, the main platform 43 comprises a circumferentially extending flap for shielding the main access aperture 14 so that contaminated air inside the rigid main housing 10 will not escape through the junction between the patient access interfacing means 40 and the main access aperture 14.

As the patient access interfacing means 40 is substantially flexible with many inflatable members, it can be made of soft and elastic materials such as PVC, EVA (ethylene vinyl acetate), elastic silicone or like materials. An exemplary thickness of the inflatable parts being in the region of 0.25 mm to strike a balance between optimal wear and workability since thick materials may be too hard to control when plastic welding is required. The dimensions of an exemplary patient access interfacing means are as follows. The internal and external diameters of the inflatable rings forming the inflatable support base are respectively 53 cm and 61 cm when fully inflated. The cross-sectional diameter of each of the inflatable rings is in the region of 7 to 8 cm. The total height of the fully inflated supporting base is therefore about 25 cm. The circumferential width of the sealing flap is about 15 cm.

As regards the inflatable tower 47 a main purpose of the inflatable tower is to form a zoom lens tower so that the separation between the patient to be examined and the viewing window 45 can be adjusted. A plurality of port holes are also provided on the main platform to provide access inside the main rigid housing when necessary. Such access is particularly useful when intubation is difficult, such as, for example, when fibre-optic guided intubation is required.

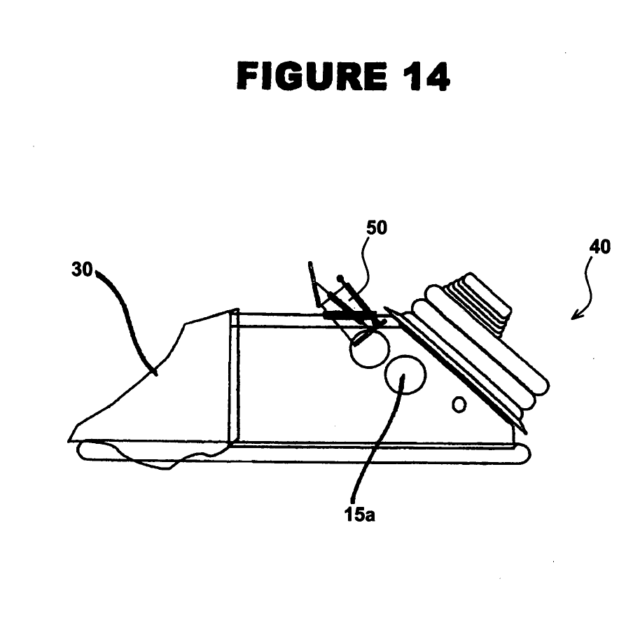

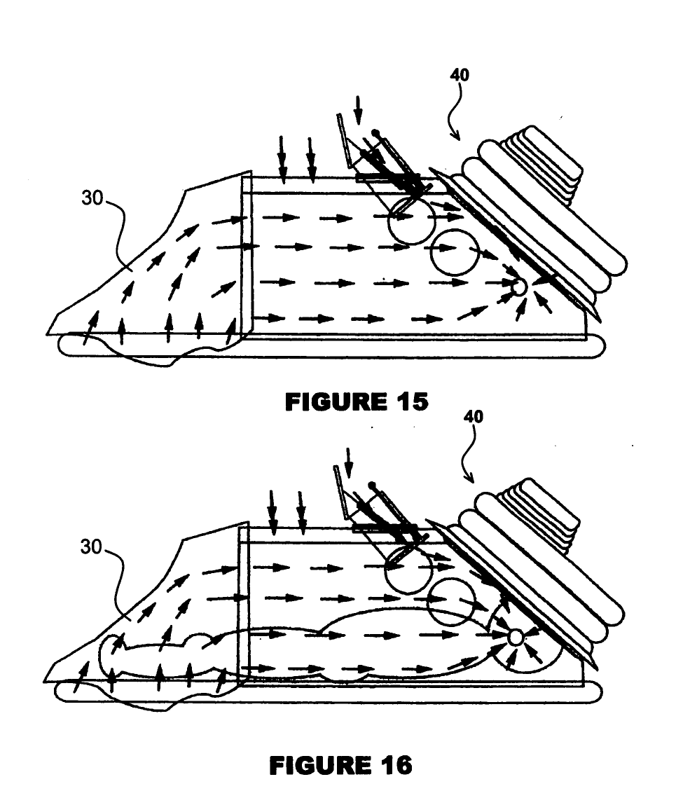

As shown in FIGS. 13 and 14, the patient interfacing means 40 are attached to the tilted front surface of the main rigid housing.

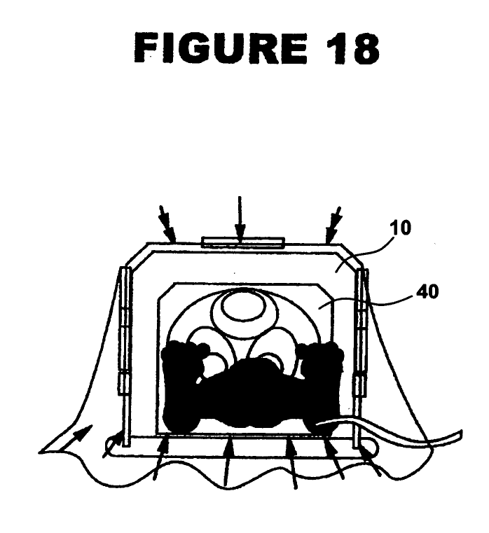

Turning now to FIGS. 15 and 18 showing the isolation chamber in normal use with arrows indicating the direction of air flow during normal use.

Referring to the Figures, during normal use, a patient is placed inside a base mattress with the patient's head adjacent to the lower end of the tilted front surface. The mattresses can be formed of an elastic material with a continuous groove for receiving the low rim of the rigid main housing in a resiliently tight relationship. The patient access interfacing means 40 is detachably attached to the tilted front surface with the inflatable tower 47 at about the 12 o'clock position. The lateral hand access apertures 15, 15a with the hand access guards 42 providing access so that a medical practitioner can access the upper body of the patient while viewing the patient's head. The patient access guards 20 on the patient access interfacing means 40 provide adjustable access to the head portion of the patient and will be explained in more detail below.

When a medical practitioner needs to perform close examination to the head portion of a patient or is required to perform emergency life-saving procedures such as intubation on the patient, the practitioner can view the head portion of the patient via the viewing window 45 by pressing his face against the air cushion. By adjusting the column height of the inflatable tower 47, the distance between the viewing window 45 and the patient can be adjusted so that the viewing window can be converted between a “macro” or a “zoom” configuration.

The patient access guards 20, including the sleeves 21 and the latex gloves 22, are attached to the main platform of the supporting base. The range accessible by the protected patient access guards 20 can be adjusted through inflation or deflation of the inflatable supporting means so that the relative distance between the main platform and the patient's head can be adjusted. By appropriately inflating or deflating the constituting base rings, a practitioner has small flexibility to reach the various positions of the patient.

Turning now to the pneumatically inflatable tower 47 and referring to FIG. 6, it is noted that the internal space of the inflatable column is connected to one of the larger inflatable rings of the supporting base via a controllable valve 32. When the valve 32 is opened so that air is communicable between the inflatable tower 47 and the base supporting ring 44, since the inflatable rings of the inflatable tower has a smaller capacity than the underlying supporting rings, pressure exerted on the inflatable column via the top cushioning ring will cause air transferred to the larger ring which as an air reservoir so that the inflatable column will be deflated, thereby reducing its height. At the same time, because of the buffering function of the larger supporting ring, there is no noticeable deformation on the supporting base rings.

Alternatively, the inflation or deflation of the inflatable means of the inflatable tower 47 and the base supporting rings 44 can be through external pneumatic source or control. In this example, the inflatable tower supporting the transparent window 45 comprises five rings with their individual cross-sectional diameters increasing away from the main platform. As the lowest ring will have the smallest internal capacity, the increase in pressure when force is being asserted at the air cushion will increase more readily at the lowest ring and air will escape first from the lowest ring and vice versa so that the height of the inflatable column can be adjusted by applying pressure onto the inflatable pressure through the cushioning ring above the inflatable tower. Likewise, as the height or thickness of the inflatable supporting base can be adjusted, the extent of the gloves attached to the main platform can be adjusted by varying the inflation status of the supporting rings without loss of generality.

During use, the lower open end of the rigid housing 10 is covered with a flexible enclosure 30 so that a balance between good shielding and a smaller rigid housing sufficient to give a reasonable extent of protection can be provided. As can be seen from the air flow arrows, air inside the rigid housing will move from the inner end which is the free end of the flexible enclosure into the rigid housing 10 and will exhaust via the exhaust hole near the head portion of the patient. As the major contaminations are in the vicinity of the head portion of a patient, any contamination will be removed as soon as their discharge by the patient.

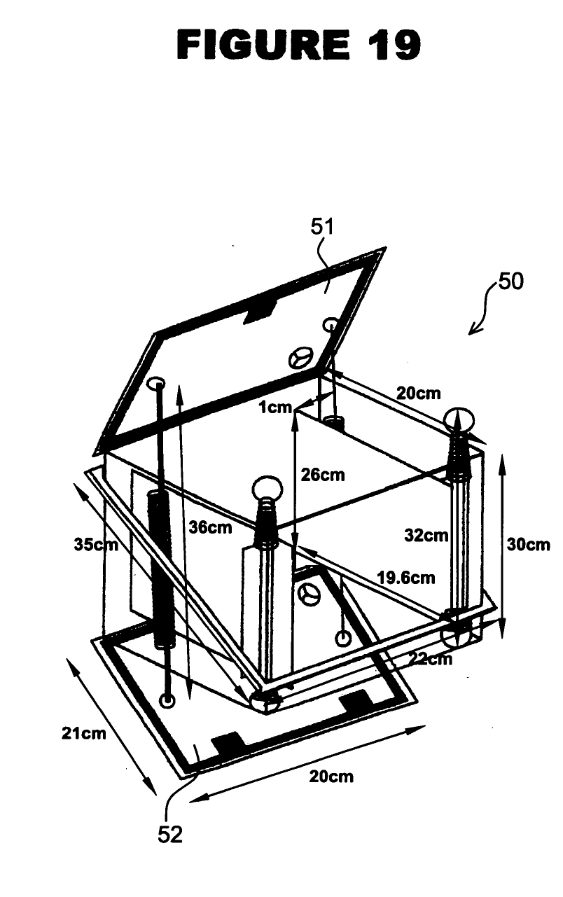

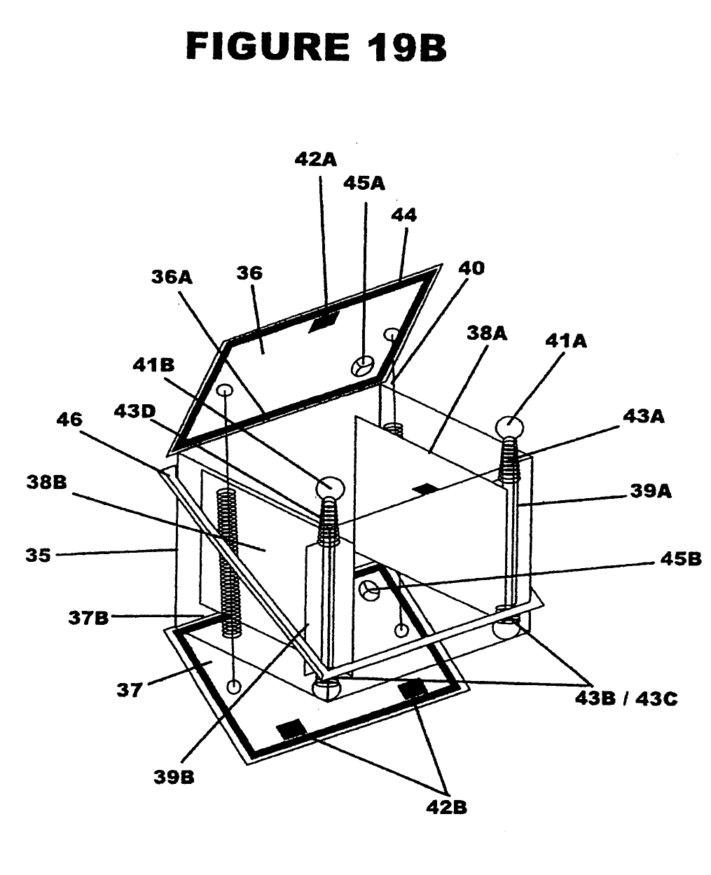

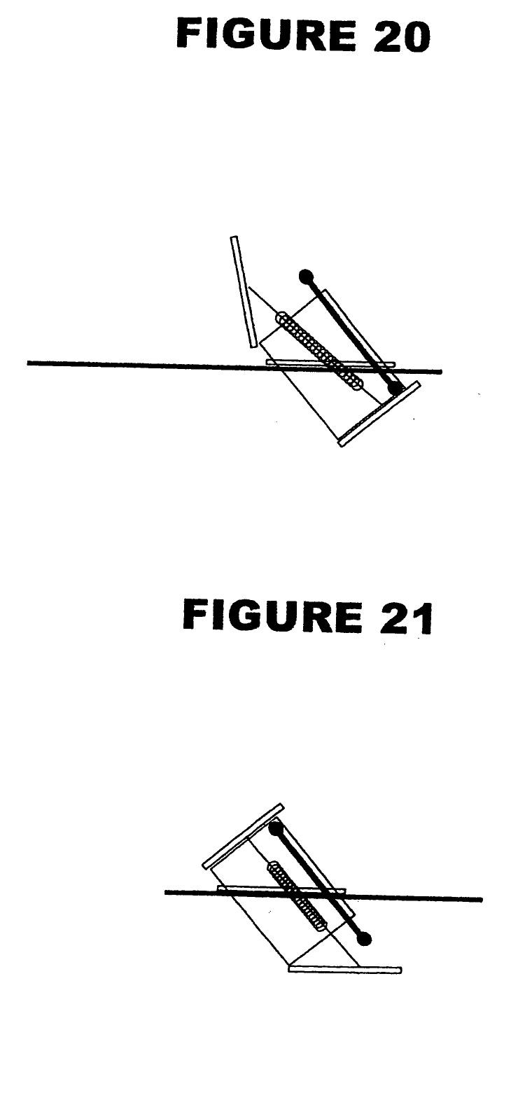

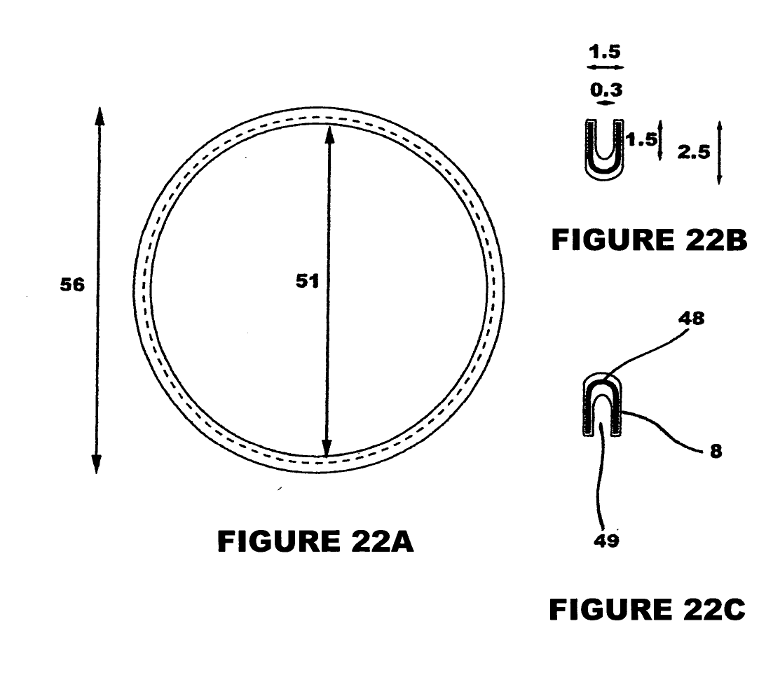

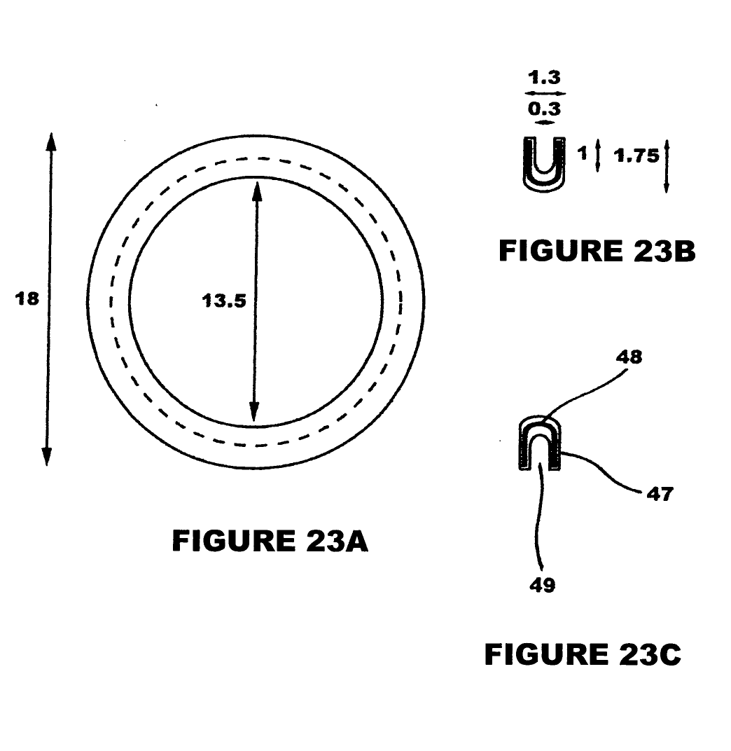

FIGS. 19A and 19B illustrate an example of a instrument transit passage 50 means for use in connection with the isolation chamber so that medical instruments or tools can pass from the outside into the isolation chamber for use by a medical practitioner. The instrument transit means in this preferred example comprises a mechanism similar to the escape chamber of a submarine. This instrument transit passage means comprises an air buffer with hinged windows which are alternatively opened so that there will be no direct passage of air inside the isolation chamber and the surrounding environment. As can be seen from the Figures, when an instrument is to be delivered into the isolation chamber, the top window 51 is opened while the bottom window 52 is closed. The instrument is to be placed inside the isolated space or chamber. After the top window has been closed, the surgeon can then open the lower window to take the instrument. As the isolation chamber is always under negative pressure due to the suction means, the risk of air leakage from the isolation chamber during operation of the top window is minimized for the safety of the surrounding personnel. The top and bottom windows can be connected by a spring so to ensure reliable alternative operation to prevent accidental leakage due to neglect or oversight.

Alternatively or additionally, the lower lid may be set to “pop” down automatically once the upper window is fully closed. The lower lid can then serve as an instrument tray for the convenience of the operating surgeons.

As an example, the negative pressure inside the isolation chamber can be maintained at about 3 cm of water or less and the vacuum suction power can be at the rating of 400 watts or above and preferably having a variable power setting for desirable control in order to be compatible with the filters which are, for example, HEPA or ULPA filters as and when necessary. Of course, pressure gauge and other monitoring or sensing means will be useful.

While the present invention has been explained by reference to the examples or preferred embodiments described above, it will be appreciated that those are examples to assist understanding of the present invention and are not meant to be restrictive. The scope of this invention should be determined and/or inferred from the preferred embodiments described above and with reference to the Figures where appropriate or when the context requires. In particular, variations or modifications which are obvious or trivial to persons skilled in the art, as well as improvements made thereon, should be considered as falling within the scope and boundary of the present invention.

Furthermore, while the present invention has been explained by reference to an isolation chamber with half-length, i.e. covering the upper body only, it should be appreciated that the invention can apply, whether with or without modification, to other isolation means without loss of generality.

1. An isolation chamber for examining and/or treating a patent, comprising:
a main housing for covering at least the upper body of a patient, said housing being adapted so that the upper body of said patient being substantially isolated from the surrounding environment when said isolation chamber is set up for normal use, said housing including an access aperture disposed at a location corresponding to near the head of said patient during use and being adapted for detachably receiving patient access interfacing means,
patient access guards adapted for allowing non-exposed manual access by the hands of an operator to the patient under protected conditions,
adjustable patient viewing means for visual examination of said patient, wherein said patient access guards and said adjustable patient viewing means being connected to a patient access interfacing means, said patient access interfacing means comprises a main platform which is supported on inflatable means so that the distance of said main platform relative to said main housing being adjustable through inflation and deflation of said inflatable means, and
said patient access interfacing means being detachably attached to said access aperture with sealing means sealing the injunction between said access aperture and said patient access interfacing means.

2. An isolation chamber according to claim 1, wherein said viewing means being supported on an inflatable supporting means which is inflatable independently of said inflatable means of said main platform so that the distance of said viewing means and the patient being treated or examined can be adjustable through inflation or deflation of said inflatable support means.

3. An isolation chamber according to claim 2, wherein said independently inflatable support means comprises a plurality of inflatable rings stacked together.

4. An isolation chamber according to claim 3, wherein the cross-sectional internal diameters of said plurality of inflatable rings increase as the rings move away from said supporting platform.

5. An isolation chamber according to claim 4, wherein a transparent viewing window is sandwiched between said inflatable support means and another independently inflatable member.

6. An isolation chamber according to claim 5, wherein said patient access guards including a pair of gloves connected to said main platform respectively via a pair of flexible sleeves which intersect said main platform at first and second hand access apertures.

7. An isolation chamber according to claim 6, wherein said viewing window, said first and second hand access apertures being disposed respectively at 12 o'clock, 4 o'clock and 8 o'clock positions.

8. An isolation chamber according to claim 5, wherein said inflatable means of said man platform and said inflatable support means being communicable via a flow control means, said inflatable means of said main platform having a substantially large capacity than said inflatable support means and acts as an air buffer for said inflatable support means.

9. An isolation chamber according to claim 1, wherein said inflatable means supporting said main platform comprises a plurality of stacked together and independently inflatable rings which are disposed between said main platform and said access aperture during normal use.

10. An isolation chamber according to claim 9, wherein said patient access interfacing means comprises a sealing ring with a peripheral sealing skirt for sealing the junction between said access interfacing means and said access aperture.

11. An isolation chamber according to claim 10, wherein said main housing resembles a tunnel covering at least the top body of a patient during use, said main housing being integrally formed from a main transparent mouldable material.

12. An isolation chamber according to claim 11, wherein said housing being made of PE, PET, PC, PP, acrylic or materials of similar characteristics.

13. An isolation chamber according to claim 1, wherein said main housing including a suction aperture adapted for detachable connection with a suction means, said suction aperture being disposed near the head of a patient under treatment so that air inside said main housing being moved out of said main housing via said suction aperture.

14. Patient access interfacing means for use with a patient isolation apparatus, comprising adjustable patient viewing means, patient access guards and means for attaching to said patient isolation apparatus, wherein, said adjustable patient means including means for visual examination of a patient, said means for attaching to said patient isolation apparatus including sealing means for sealing a junction between said patient isolation apparatus and said patient access interfacing means, patient access guards being adapted for allowing non-exposed manual access by the hands of an operator to the patient under protected conditions, said patient viewing means and said patient access guards being mounted on a main platform which is supported on inflatable means so that the distance of said main platform relative to said main housing being adjustable through inflation and deflation of said inflatable means.
